(19) United States
(12) Patent Application Publication
(10) Pub. No.: US 2025/0307045 A1
(43) Pub. Date: Oct. 2, 2025

(54) SYSTEMS AND METHODS FOR PREEMPTIVE DETECTION AND MITIGATION OF CHIPLET LINK FAILURES

(71) Applicants: Advanced Micro Devices, Inc., Santa Clara, CA (US); ATI Technologies ULC, Markham (CA)

(72) Inventors: Robert Landon Pelt, Austin, TX (US); David Akselrod, Markham (CA); Alexander J. Branover, Boxborough, MA (US)

(73) Assignees: Advanced Micro Devices, Inc., Santa Clara, CA (US); ATI Technologies ULC, Markham (CA)

(21) Appl. No.: 18/622,696

(22) Filed: Mar. 29, 2024

(51) Int. Cl. G06F 11/07

(52) U.S. Cl. CPC G06F 11/076; G06F 11/0793

(57) ABSTRACT

A method for preemptive detection and mitigation of chiplet link failures can include measuring, by at least one processor, a bit error rate of at least one communications channel between two or more semiconductor processing units. The method can also include triggering, by the at least one processor and based on the measured bit error rate and one or more sensed environmental conditions, a preemptive action prior to failure of the at least one communications channel. Various other methods and systems are also disclosed.

### BACKGROUND

Chiplets are integrated circuits manufactured on a discrete die that contain a subset of functionality and are combined with other chiplets (e.g., on an interposer, in a die, in stacked dies, etc.) in a single package. Chiplets are a way of segmenting integrated circuits, rather than using a single piece of silicon with all the parts (e.g., a monolithic approach). Chiplets can allow manufacturers to use multiple smaller chips to make up a larger integrated circuit like a computer processor. Chiplets can be connected together on a substrate, on an interposer, or by physical macros between stacked die to provide data transfer between devices in a package.

Reliability of communications channels between chiplets (e.g., connected in a same package, in different packages and connected on a same circuit board, etc.) can impact performance of critical systems in safety-critical applications, such as vehicle control. Today's control systems (e.g., vehicle control systems) can reinitialize and/or retrain communications channels upon detected chiplet link failure. Such procedures can potentially result in delay of control messaging in a manner that can impact message delivery, non-conflicting messages, and minimum time of delivery.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1A is a flow diagram of an example method for preemptive detection and mitigation of chiplet link failures.

FIG. 1B is a block diagram illustrating an example system implementing preemptive detection and mitigation of chiplet link failures.

FIG. 2 is a block diagram illustrating example systems for preemptive detection and mitigation of chiplet link failures.

FIG. 3 is a block diagram illustrating an example implementation of the systems and methods of FIGS. 1A, 1B, and 2.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for preemptive detection and mitigation of chiplet link failures. For example, by measuring a bit error rate of communications channel(s) between semiconductor processing units and triggering a preemptive action prior to failure of the communications channel(s) (e.g., based on the measured bit error rate and one or more sensed environmental conditions), the disclosed systems and methods can reduce and/or avoid chiplet link failures.

The disclosed systems and methods can achieve numerous benefits. For example, many high-reliability applications (e.g., automotive and aerospace), systems must continue to operate during partial failures. The disclosed systems and methods can perform monitoring and take preemptive action(s) to ensure high-reliability systems can continue to operate without interruption (e.g., although at a reduced functionality). In some implementations, system failure mechanisms can change depending on the environmental conditions. The disclosed systems and methods can support using collected data to determine necessary changes to the chiplet link and preemptively trigger appropriate actions.

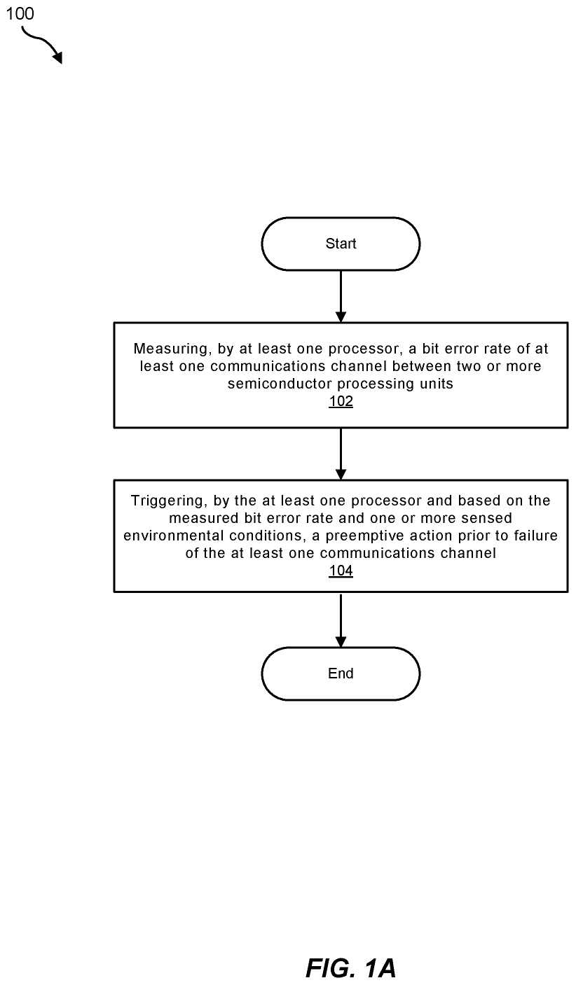

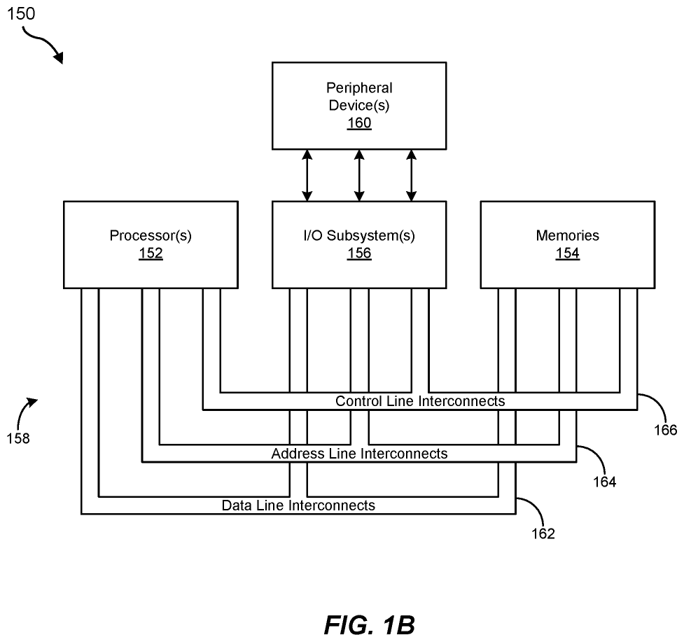

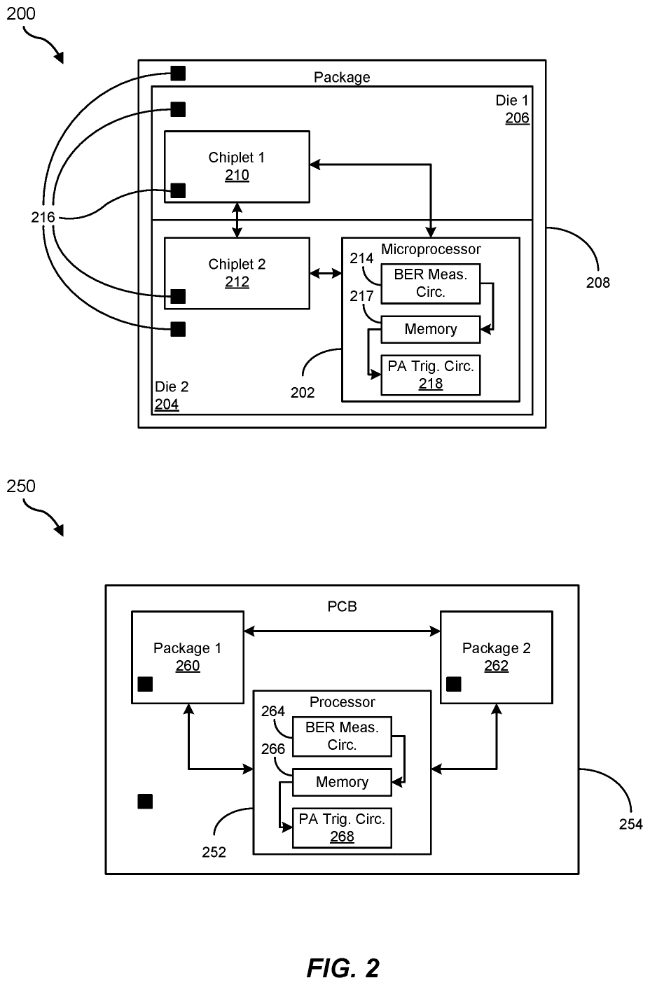

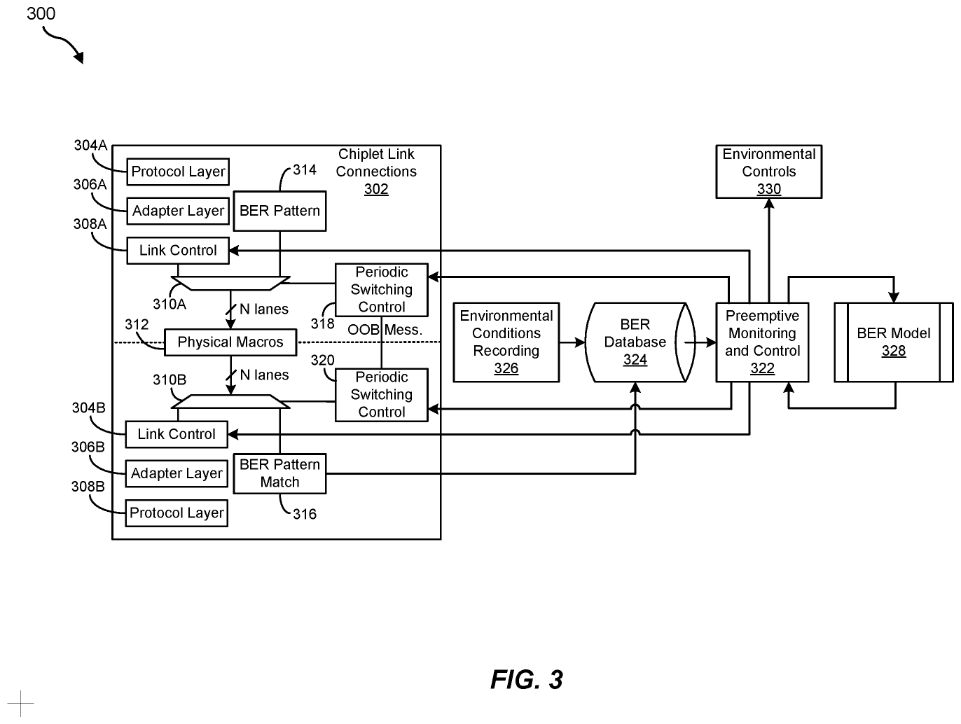

The following will provide, with reference to FIG. 1A, detailed descriptions of computer-implemented methods for preemptive detection and mitigation of chiplet link failures. In addition, detailed descriptions of example systems for preemptive detection and mitigation of chiplet link failures will be provided in connection with FIGS. 1B and 2. Also, detailed descriptions of example implementations of the disclosed systems and methods will be provided in connection with FIG. 3.

In one example, a device can include bit error rate measurement circuitry configured to measure a bit error rate of at least one communications channel between two or more semiconductor processing units, and preemptive action triggering circuitry configured to trigger, based on the measured bit error rate and one or more sensed environmental conditions, a preemptive action prior to failure of the at least one communications channel.

Another example can be the previously described example device, wherein the one or more sensed environmental conditions relate to at least one of the two or more semiconductor processing units.

Another example can be any of the previously described example devices, wherein the predictive action triggering circuitry is further configured to trigger the two or more semiconductor processing units to begin measuring of the bit error rate in response to the one or more sensed environmental conditions meeting at least one threshold condition.

Another example can be any of the previously described example devices, wherein the preemptive action triggering circuitry is further configured to at least one of modify or end an ongoing preemptive action based on the measured bit error rate and the one or more sensed environmental conditions.

Another example can be any of the previously described example devices, wherein the preemptive action corresponds to lowering a clock rate of the two or more semiconductor processing units, disabling one or more lanes of the at least one communications channel, increasing one or more error correction capabilities of the at least one communications channel, triggering one or more environmental controls to change an operating state of the two or more semiconductor processing units, and/or triggering retraining of at least part of the at least one communications channel.

Another example can be any of the previously described example devices, wherein the one or more environmental controls include chiplet level controls corresponding to chiplet power controls, chiplet clocking controls, and/or chiplet workload controls.

Another example can be any of the previously described example devices, wherein the one or more sensed environmental conditions include temperature, power consumption, and/or package stress of at least one semiconductor device package including at least one of the two or more semiconductor processing units.

Another example can be any of the previously described example devices, wherein the bit error rate measurement circuitry is further configured to record the measured bit error rate in a memory in which measured bit error rates are sorted by the one or more sensed environmental conditions.

Another example can be any of the previously described example devices, wherein the bit error rate measurement circuitry is further configured to measure the bit error rate using predetermined patterns that stress link characteristics of the at least one communications channel.

Another example can be any of the previously described example devices, wherein the preemptive action triggering circuitry is further configured to trigger the preemptive action based on a predictive bit error rate model of bit error rates over a plurality of the one or more sensed environmental conditions.

Another example can be any of the previously described example devices, wherein the preemptive action triggering circuitry is further configured to reverse the preemptive action based on the measured bit error rate and/or the one or more sensed environmental conditions.

In one example, a system can include a memory recording one or more measurements of bit error rates of at least one communications channel between two or more semiconductor processing units, and at least one processor configured to trigger, based on the one or more measurements and one or more sensed environmental conditions, a preemptive action prior to failure of the at least one communications channel.

Another example can be the previously described example system, wherein the one or more sensed environmental conditions relate to at least one of the two or more semiconductor processing units.

Another example can be any of the previously described example systems, wherein the at least one processor is further configured to trigger the two or more semiconductor processing units to begin measurement of the bit error rates in response to the one or more sensed environmental conditions meeting at least one threshold condition.

Another example can be any of the previously described example systems, wherein the preemptive action corresponds to lowering a clock rate of the two or more semiconductor processing units, disabling one or more lanes of the at least one communications channel, increasing one or more error correction capabilities of the at least one communications channel, triggering one or more environmental controls to change an operating state of the two or more semiconductor processing units, and/or triggering retraining of at least part of the at least one communications channel.

Another example can be any of the previously described example systems, wherein the one or more sensed environmental conditions include temperature, power consumption, and/or package stress of at least one semiconductor device package including at least one of the two or more semiconductor processing units.

Another example can be any of the previously described example systems, wherein the at least one processor is further configured to record the one or more measurements in a memory in which measured bit error rates are sorted by the one or more sensed environmental conditions.

Another example can be any of the previously described example systems, wherein the at least one processor is further configured to measure the bit error rates using predetermined patterns that stress link characteristics of the at least one communications channel.

Another example can be any of the previously described example systems, wherein the at least one processor is further configured to trigger the preemptive action based on a predictive bit error rate model of the bit error rates over a plurality of the one or more sensed environmental conditions.

In one example, a method can include measuring, by at least one processor, a bit error rate of at least one communications channel between two or more semiconductor processing units, and triggering, by the at least one processor and based on the measured bit error rate and one or more sensed environmental conditions, a preemptive action prior to failure of the at least one communications channel.

FIG. 1A is a flow diagram of an example computer-implemented method 100 for preemptive detection and mitigation of chiplet link failures. The steps shown in FIG. 1A can be performed by any suitable computer-executable code, computing system, processor, microprocessor, hardware circuitry, and/or variations or combinations of one or more of the same. In one example, each of the steps shown in FIG. 1A can represent an algorithm (e.g., implemented in hardware and/or software) whose structure includes and/or is represented by multiple sub-steps, examples of which will be provided in greater detail below.

The term “computer-implemented,” as used herein, can generally refer to hardware, software, or any combination thereof. For example, and without limitation, computer-implemented can refer to specific hardware logic configured to preemptively detect and mitigate chiplet link failures. Alternatively, computer-implemented can refer to software configured to preemptively detect and mitigate chiplet link failures. Alternatively, computer-implemented can refer to a general-purpose processor in combination with software that configures the general-purpose processor to preemptively detect and mitigate chiplet link failures. Alternatively, computer-implemented can refer to a combination of a general-purpose processor, software, and/or specific hardware logic configured to preemptively detect and mitigate chiplet link failures.

The terms “processor” and “physical processor,” as used herein, can generally refer to any circuitry capable of preemptively detect and mitigate chiplet link failures. For example, and without limitation, processor and/or physical processor can refer to a microprocessor (e.g., root of trust (ROT) microprocessor) implemented in a die of a semiconductor device (e.g., a core compute die). Alternatively or additionally, processor and/or physical processor can refer to a central processing unit (CPU) and/or a co-processor (e.g., graphics processing unit (GPU), accelerator processing unit (APU), etc.) of a semiconductor device, a semiconductor device package, or a printed circuit board (PCB) (e.g., motherboard, control board, etc.) by which semiconductor device packages are connected, etc.

As illustrated in FIG. 1A, at step 102, one or more of the systems described herein can measure a bit error rate. For example, method 100 can, at step 102, measure, by at least one processor, a bit error rate of at least one communications channel between two or more semiconductor processing units.

The term “bit error rate,” as used herein, can generally refer to a ratio. For example, and without limitation, bit error rate can refer to a ratio between a number of bits incorrectly received and a total number of bits transmitted through a communications channel. In this context, a bit error rate (BER) can be measured by transmitting predefined patterns of bits over a communications channel, attempting to match patterns of bits received over the communications channel to the predetermined patterns, and generating the ratio based on a number of failed attempts and a number of successful attempts.

The term “communications channel,” as used herein, can generally refer to one or more connections over which data can be transferred. For example, and without limitation, communications channels can be individual connections and/or groups of connections of a data communication bus. These connections can correspond, for example, to logical channels and/or physical channels. In this context, a set of communications channels of a data communication bus can include communications channels currently being used for exchange of data according to a current channel configuration (e.g., occupied lanes). Alternatively or additionally, a set of communications channels of a data communication bus can include communication channels that are active but that are not currently being used for exchange of data according to a current channel configuration (e.g., spare lanes).

The term “semiconductor processing unit,” as used herein, can generally refer to a processor implemented in semiconductor technology. For example, and without limitation, a semiconductor processing unit can correspond to a processing unit, a microprocessing unit, a chiplet, a root of trust (ROT) microprocessor of a chiplet, a central processing unit, a co-processing unit, a monolithic processing unit, a system on chip (SoC), etc. In this context, a semiconductor processing unit can be implemented in a die of a plurality of stacked die of a semiconductor device, in a semiconductor device package, on a printed circuit board (PCB) to which semiconductor device packages are connected, on a different PCB connected to the PCB to which semiconductor device packages are connected, combinations thereof, etc.

The steps described herein can perform step 102 in a variety of ways. For example, the one or more sensed environmental conditions (e.g., temperature, power consumption, package stress of at least one semiconductor device package including at least one of the two or more semiconductor processing units, etc.) can relate to at least one of the two or more semiconductor processing units. In some implementations, method 100 can, at step 102, trigger the two or more semiconductor processing units to begin measurement of the bit error rate in response to the one or more sensed environmental conditions meeting at least one threshold condition. Alternatively or additionally, method 100 can, at step 102, measure the bit error rate periodically and/or when link events (e.g., cyclic redundancy check (CRC) errors, link retries, etc.) meet a threshold condition. In some implementations, method 100 can, at step 102, measure the bit error rate using predetermined patterns that stress link characteristics (e.g., toggle rate, cross talk, etc.) of the at least one communications channel. Finally, method 100 can, at step 102, record the measured bit error rate in a memory in which measured bit error rates are sorted by the one or more sensed environmental conditions. In this way, method 100 can predict potential high bit error rate events by monitoring environmental conditions.

The term “memory,” as used herein, can generally refer to any computer hardware capable of storing and/or transforming information. For example, and without limitation, a memory can correspond to hardware, software, or combinations thereof. In turn, hardware can correspond to analog circuitry, digital circuitry, communication media, or combinations thereof. In this context, a memory can be an internal memory of a processor, a memory external to a processor, or combinations thereof. Specific types of memory can include main memory, random access memory (e.g., static random access memory (SRAM), dynamic random access memory (DRAM), etc.), registers, buffers, etc.

As illustrated in FIG. 1A, at step 104, one or more of the systems described herein can trigger a preemptive action. For example, method 100 can, at step 104, trigger, by the at least one processor and based on the measured bit error rate and one or more sensed environmental conditions, a preemptive action prior to failure of the at least one communications channel.

The term “preemptive action,” as used herein, can generally refer to any action that can potentially avoid failure of a communications channel before the failure occurs. For example, and without limitation, preemptive actions can include lowering a clock rate, disabling lanes, increasing error correction capabilities, triggering environmental controls, triggering retraining, etc.

The term “trigger,” as used herein, can generally refer to causing an event or situation to happen or exist. For example, and without limitation, triggering can refer to transmitting a control signal to a unit configured to cause an event and/or situation. In this context, a control signal can be accompanied by arguments that specify what type of event or situation should be caused and/or a manner in which and/or a degree to which the event or situation should be caused. Specific types of triggering can include transmitting one or more control signals to units capable of reducing numbers of lanes, reducing power, reducing clock rate(s), and/or reducing chiplet workloads. In this context, the control signal(s) can specify which type(s) of actions should be performed and/or one or more amounts by which numbers of lanes, power, clock rate, and or workload should be reduced.

The steps described herein can perform step 104 in a variety of ways. In one example, method 100 can, at step 104, modify and/or end an ongoing preemptive action based on the measured bit error rate and the one or more sensed environmental conditions. In another example, method 100 can, at step 104, trigger a preemptive action corresponding to lowering a clock rate of the two or more semiconductor processing units, disabling one or more lanes of the at least one communications channel, increasing one or more error correction capabilities of the at least one communications channel, triggering one or more environmental controls to change an operating state of the two or more semiconductor processing units, and/or triggering retraining of at least part of the at least one communications channel. In the context of triggering environmental controls, method 100 can, at step 104, trigger one or more chiplet level controls corresponding to chiplet power controls, chiplet clocking controls, and/or chiplet workload controls. In some implementations, method 100 can, at step 104, trigger the preemptive action based on a predictive bit error rate model of bit error rates over a plurality of the one or more sensed environmental conditions. Finally, method 100 can, at step 104, reverse the preemptive action based on at least one of the measured bit error rate or the one or more sensed environmental conditions. In this way, method 100 can use predictions to preemptively change chiplet link properties (e.g., reduce clock rate, reduce lane usage, etc.) and return the chiplet links to full bandwidth when known conditions are met.

FIG. 1B illustrates an example system 150 implementing preemptive detection and mitigation of chiplet link failures. For example, system 150 can include one or more processors 152, one or more memories 154, and one or more input/output (I/O) subsystems 156 connected by a system bus 158. Processors 152 can include central processing units (CPUs) and/or co-processors, such as graphics processing units (GPUs), accelerator processing units (APUs), arithmetic logic units (ALUs), etc. Memories 154 can correspond to electronic holding places for the instructions and/or data that a computer needs to reach quickly, such as cache memory, main memory, and/or secondary memory. I/O subsystems 156 can correspond to devices that transfer data to and/or from a computer and control communication between processors 152 and peripheral devices 160. Peripheral devices 160 can correspond to devices that connect to a core computing unit, such as monitors, mice, keyboards, printers, external memory, etc. In turn, I/O subsystems 156 can include controllers for each of the peripheral devices 160. One or more processors 152, one or more memories 154, and one or more input/output (I/O) subsystems 156 can be implemented as one or more semiconductor device packages connected to one or more printed circuit boards.

As shown in FIG. 1B, a system bus 158 can be a communication system that transfers data between components inside a computer, or between computers. System bus 158 can include various interconnects, such as data line interconnects 162, address line interconnects 164, and control line interconnects 166. Data line interconnects 162, in the context of technology and computing, can refer to a communication path that facilitates the transmission of data between devices or systems. Address line interconnects 164 can refer to a physical connection between a CPU/chipset and memory and specify which address to access in the memory. Control line interconnects 166 can receive signals that manage varied chip operations (e.g., scan and write). One or more processors 152, one or more memories 154, one or I/O subsystems 156, and/or system bus 158 can implement preemptive detection and mitigation of chiplet link failures as described herein.

FIG. 2 illustrates example systems 200 and 250 for preemptive detection and mitigation of chiplet link failures, and these example systems 200 and 250 can implement the method of FIG. 1A. For example, system 200 can include a device implemented as a microprocessor 202 of a die 204 among stacked die 204 and 206 of a semiconductor device included in a semiconductor device package 208. Die 206 can include a first semiconductor processing unit corresponding to a first chiplet 210 and die 204 can include a second semiconductor processing unit corresponding to a second chiplet 212. The first chiplet 210 and the second chiplet 212 can communicate by one or more communications channels and have a capability to measure a bit error rate over the one or more communications channels (e.g., periodically, upon link events meeting a threshold condition, and/or in response to triggering control signals from microprocessor 202). The first chiplet 210 and the second chiplet 212 can also report measured bit error rate(s) to the microprocessor 202.

In operation, bit error rate measurement circuitry 214 of microprocessor 202 can receive sensed environmental conditions from one or more sensors 216 of semiconductor device package 208. These sensors 216 can be located in or on the semiconductor device package 208, the stacked die 204 and 206, the first chiplet 210, and/or the second chiplet 212. Sensors 216 can also include power sensors, temperature sensors, and/or impact sensors. Bit error rate measurement circuitry 214 can record the sensed environmental conditions in memory 217 of the microprocessor 202. Bit error rate measurement circuitry 214 can also receive measurements of bit error rates from the first chiplet 210 and/or the second chiplet 212. Bit error rate measurement circuitry 214 can further record these measurements in the memory 217 of the microprocessor 202. In some implementations, bit error rate measurement circuitry 214 can record the measurements in the memory 217 in a manner that sorts (e.g., categorizes) the measurements by the sensed environmental conditions (e.g., one or combinations of sensed environmental conditions).

As shown in FIG. 2, preemptive action triggering circuitry 218 can read the sensed environmental conditions recorded in memory 217. Preemptive action triggering circuitry 218 can also trigger the first chiplet 210 and the second chiplet 212 to begin measuring the bit error rate of the one or more communications channels. Preemptive action triggering circuitry 218 can trigger the first chiplet 210 and the second chiplet 212 to begin measuring the bit error rate periodically, upon link events meeting a threshold condition, and/or in response to one or more of the sensed environmental conditions meeting one or more threshold conditions (e.g., one or more high power threshold(s), one or more high temperature threshold(s), one or more high impact threshold(s), combinations thereof, etc.). Preemptive action triggering circuitry 218 can further read data recorded in a predictive bit error rate model stored in memory 217. The predictive bit error rate model can correspond to a model (e.g., table, list, matrix, tree, neural network, etc.) of bit error rates over a plurality of the one or more sensed environmental conditions.

Using data of the predictive bit error rate model and based on the measured bit error rate and the one or more sensed environmental conditions, preemptive action triggering circuitry 218 can predict link failure of the one or more communications channels between the first chiplet 210 and/or the second chiplet 212. In response to this prediction, preemptive action triggering circuitry 218 can select one or more appropriate preemptive actions based on preconfigured selection criteria, which can consider the measured bit rate and/or the sensed environmental conditions. These preconfigured selection criteria can be programmed by a manufacturer based on electronic design automation (EDA) tools and/or updated by a manufacturer based on performance data that can be periodically uploaded (e.g., over a vehicle communications bus) and aggregated with other uploads of other vehicles.

Preemptive action triggering circuitry 268 can trigger the one or more preemptive actions to avoid link failure of the one or more communications channels. In one or more implementations, preemptive action triggering circuitry 218 can trigger one or more preemptive actions corresponding to lowering a clock rate of the first chiplet 210 and the second chiplet 212, disabling one or more lanes of the one or more communications channels, increasing one or more error correction capabilities of the one or more communications channels, triggering one or more environmental controls to change an operating state of the first chiplet 210 and the second chiplet 212, and/or triggering retraining of at least part of the one or more communications channels. In the context of triggering environmental controls, preemptive action triggering circuitry 218 can trigger one or more chiplet level controls corresponding to chiplet power controls, chiplet clocking controls, and/or chiplet workload controls. In triggering such actions, preemptive action triggering circuitry 218 can transmit control signals and/or messages to the first chiplet 210 and/or the second chiplet 212, to another processor of the package 208, and/or to another package (e.g., CPU, GPU, APU, etc.).

As shown in FIG. 2, example system 250 can include a device implemented as a processor 252 of a PCB 254 that is connected to a first semiconductor processing unit corresponding to a first package 260 and a second semiconductor processing unit corresponding to a second package 262. Chiplets of the first package 260 and the second package 262 can communicate with one another by one or more communications channels and have a capability to measure a bit error rate over the one or more communications channels (e.g., periodically, upon link events meeting a threshold condition, and/or in response to triggering control signals from processor 252). The first package 260 and the second package 262 can also report measured bit error rate(s) to the processor 252.

In operation, bit error rate measurement circuitry 264 of processor 252 can receive sensed environmental conditions from one or more sensors of the first package 260, the second package 262, and/or the PCB 254. These sensors can be located in and/or on the first package 260, in and/or on the second package 262, in stacked die thereof, in chiplets thereof, and/or on the PCB 254. These sensors can also include power sensors, temperature sensors, and/or impact sensors. Bit error rate measurement circuitry 264 can record the sensed environmental conditions in memory 266 of the processor 252. Bit error rate measurement circuitry 264 can also receive measurements of bit error rates from the first package 260 and/or the second package 262. Bit error rate measurement circuitry 264 can further record these measurements in the memory 266 of the processor 252. In some implementations, bit error rate measurement circuitry 264 can record the measurements in the memory 266 in a manner that sorts (e.g., categorizes) the measurements by the sensed environmental conditions (e.g., one or combinations of sensed environmental conditions).

As shown in FIG. 2, preemptive action triggering circuitry 268 can read the sensed environmental conditions recorded in memory 266. Preemptive action triggering circuitry 268 can also trigger the first package 260 and the second package 262 to begin measuring the bit error rate of the one or more communications channels. Preemptive action triggering circuitry 268 can trigger the first package 260 and the second package 262 to begin measuring the bit error rate periodically, upon link events meeting a threshold condition, and/or in response to one or more of the sensed environmental conditions meeting one or more threshold conditions (e.g., one or more high power threshold(s), one or more high temperature threshold(s), one or more high impact threshold(s), combinations thereof, etc.). Preemptive action triggering circuitry 268 can further read data recorded in a predictive bit error rate model stored in memory 266. The predictive bit error rate model can correspond to a model (e.g., table, list, matrix, tree, neural network, etc.) of bit error rates over a plurality of the one or more sensed environmental conditions.

Using data of the predictive bit error rate model and based on the measured bit error rate and the one or more sensed environmental conditions, preemptive action triggering circuitry 268 can predict link failure of the one or more communications channels between the first package 260 and/or the second package 262. In response to this prediction, preemptive action triggering circuitry 268 can select one or more appropriate preemptive actions based on preconfigured selection criteria, which can consider the measured bit rate and/or the sensed environmental conditions. These preconfigured selection criteria can be programmed by a manufacturer based on electronic design automation (EDA) tools and/or updated by a manufacturer based on performance data that can be periodically uploaded (e.g., over a vehicle communications bus) and aggregated with other uploads of other vehicles.

Preemptive action triggering circuitry 268 can trigger the one or more preemptive actions to avoid link failure of the one or more communications channels. In one or more implementations, preemptive action triggering circuitry 268 can trigger one or more preemptive actions corresponding to lowering a clock rate of a first chiplet of the first package 260 and a second chiplet of the second package 262, disabling one or more lanes of the one or more communications channels, increasing one or more error correction capabilities of the one or more communications channels, triggering one or more environmental controls to change an operating state of the first chiplet of the first package 260 and the second chiplet of the second package 262, and/or triggering retraining of at least part of the one or more communications channels. In the context of triggering environmental controls, preemptive action triggering circuitry 268 can trigger one or more chiplet level controls corresponding to chiplet power controls, chiplet clocking controls, and/or chiplet workload controls. In triggering such actions, preemptive action triggering circuitry 268 can transmit control signals and/or messages to the first chiplet of the first package 260 and/or the second chiplet of the second package 262, to one or more other processors of the first package 260 and/or the second package 262, and/or to another package (e.g., CPU, GPU, APU, etc.) connected to the PCB 254.

As shown in FIG. 2, processor 252 can be implemented as a separate package (e.g., CPU, GPU, APU) connected to PCB 254. Alternatively, processor 252 can be implemented as a microprocessor of the first package 260 or the second package 262 (e.g., on package, on die, etc.). Moreover, memory 217 and/or 266 can be implemented as internal memory of microprocessor 202 and/or processor 252. Alternatively or additionally, all or part of memory 217 and/or 266 can be implemented as external memory on a different die or package than one in which microprocessor 202 and/or processor 252 is located. Moreover, a database storing the measured bit error rates categorized by the sensed environmental conditions can be recorded in a portion of the memory that is not collocated (e.g., different die or package) with another portion of the memory recording the predictive bit error rate model in some implementations. Finally, contents of the database storing the measured bit error rates categorized by the sensed environmental conditions can be periodically uploaded (e.g., over a vehicle communications bus) and aggregated with other uploads of other vehicles to update the predictive bit error rate model (e.g., by a manufacturer), and an updated predictive bit error rate models can be downloaded that replace the one stored in memory 217 and/or 266.

FIG. 3 illustrates an example implementation 300 of the systems and methods of FIGS. 1A, 1B, and 2. For example, implementation 300 can include chiplet link connections 302 having protocol layers 304A and 304B, adapter layers 306A and 306B, and link controls 308A and 308B. The chiplet link connections 302 can also include communications bridges 310A and 310B (e.g., multiplexers, demultiplexers, AND gates, OR gates, etc.) that transmit and/or receive bits to and/or from link controls 308A and 308B over multiple lanes of a communications channel implemented by physical macros 312 at a chiplet boundary of the chiplet link connections 302. Additionally, chiplet link connections 302 can include a bit error rate pattern generator 314 and a bit error rate pattern matcher 316 arranged as shown. Periodic switching controls 318 and 320 of the chiplet link connections 302 can communicate with one another over the chiplet link barrier by out of band messaging, and these controls 318 and 320 can periodically switch the communication bridges 310A and 310B to route bit patterns from bit error rate pattern generator 314 to bit error rate pattern matcher 316 over one or more lanes of the communications channel implemented by physical macros 312. These periodic switching controls 318 and 320 can also route bit patterns from bit error rate pattern generator 314 to bit error rate pattern matcher 316 over one or more lanes of the communications channel implemented by physical macros 312 in response to control signals form a preemptive monitoring and control unit 322.

In operation, bit error rate pattern generator 314 can generate patterns of bits according to predefined patterns that stress link characteristics (e.g., toggle rate, cross talk, etc.) of the communications channel implemented by physical macros 312. Additionally, bit error rate pattern matcher 316 can attempt to match patterns of bits received over the communications channel to one or more of the predetermined patterns, generate a ratio based on a number of failed attempts and a number of successful attempts, and record the ratio in a bit error rate database 324. Environmental conditions recording unit 326 can also receive sensed environmental conditions and record them in the bit error rate database 324 in association with ratios recorded currently by the bit error rate pattern matcher 316. As a result, the measured bit error rates recorded in the bit error rate database 324 can be categorized and/or sorted by the environmental conditions sensed at the time the measurements are made.

As shown in FIG. 3, preemptive monitoring and control unit 322 can read current sensed environmental conditions stored in the bit error rate database 324 and trigger the periodic switching controls 318 and 320 to begin measurement of the bit error rate of the communication channel implemented by physical macros 312. Preemptive monitoring and control unit 322 can trigger the periodic switching controls 318 and 320 to begin measurement of the bit error rate periodically, upon link events meeting a threshold condition, and/or in response to one or more of the sensed environmental conditions meeting one or more threshold conditions (e.g., one or more high power threshold(s), one or more high temperature threshold(s), one or more high impact threshold(s), combinations thereof, etc.). Preemptive monitoring and control unit 322 can further read data recorded in a predictive bit error rate model 328 stored in memory. The predictive bit error rate model 328 can correspond to a model (e.g., table, list, matrix, tree, neural network, etc.) of bit error rates over a plurality of the one or more sensed environmental conditions.

Using data of the predictive bit error rate model 328 and based on the measured bit error rate and the one or more sensed environmental conditions, preemptive monitoring and control unit 322 can predict link failure of the one or more communications channels implemented by the physical macros 312. In response to this prediction, preemptive monitoring and control unit 322 can select one or more appropriate preemptive actions based on preconfigured selection criteria, which can consider the measured bit rate and/or the sensed environmental conditions. These preconfigured selection criteria can be programmed by a manufacturer based on electronic design automation (EDA) tools and/or updated by a manufacturer based on performance data that can be periodically uploaded (e.g., over a vehicle communications bus) and aggregated with other uploads of other vehicles.

Preemptive monitoring and control unit 322 can trigger the one or more preemptive actions to avoid link failure of the one or more communications channels implemented by physical macros 312. In one or more implementations, preemptive monitoring and control unit 322 can trigger one or more preemptive actions corresponding to lowering a clock rate of one or more chiplets, disabling one or more lanes of the one or more communications channels, increasing one or more error correction capabilities of the one or more communications channels, triggering one or more environmental controls 330 to change an operating state of one or more chiplets, and/or triggering retraining of at least part of the one or more communications channels. In the context of triggering environmental controls 330, preemptive monitoring and control unit 322 can trigger one or more chiplet level controls corresponding to chiplet power controls, chiplet clocking controls, and/or chiplet workload controls. In triggering such actions, preemptive monitoring and control unit 322 can transmit control signals and/or messages to one or more chiplets, to one or more other processors of one or more packages, and/or to another package (e.g., CPU, GPU, APU, etc.).

As set forth above, the disclosed systems and methods can achieve preemptive detection and mitigation of chiplet link failures. For example, by measuring a bit error rate of communications channel(s) between semiconductor processing units and triggering a preemptive action prior to failure of the communications channel(s) (e.g., based on the measured bit error rate and one or more sensed environmental conditions), the disclosed systems and methods can reduce or avoid chiplet link failures.

The disclosed systems and methods can achieve numerous benefits. For example, many high-reliability applications (e.g., automotive and aerospace), systems must continue to operate during partial failures. The disclosed systems and methods can perform monitoring and take preemptive action(s) to ensure that high-reliability systems can continue to operate without interruption (e.g., although at a reduced functionality). In some implementations, system failure mechanisms can change depending on the environmental conditions. The disclosed systems and methods can support using collected data to determine necessary changes to the chiplet link and preemptively trigger appropriate actions.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
bit error rate measurement circuitry configured to measure a bit error rate of at least one communications channel between two or more semiconductor processing units; and
preemptive action triggering circuitry configured to trigger, based on the measured bit error rate and one or more sensed environmental conditions, a preemptive action prior to failure of the at least one communications channel.

2. The device of claim 1, wherein the one or more sensed environmental conditions relate to at least one of the two or more semiconductor processing units.

3. The device of claim 1, wherein the preemptive action triggering circuitry is further configured to trigger the two or more semiconductor processing units to begin measuring of the bit error rate in response to the one or more sensed environmental conditions meeting at least one threshold condition.

4. The device of claim 1, wherein the preemptive action triggering circuitry is further configured to at least one of modify or end an ongoing preemptive action based on the measured bit error rate and the one or more sensed environmental conditions.

5. The device of claim 1, wherein the preemptive action corresponds to at least one of:
lowering a clock rate of the two or more semiconductor processing units;
disabling one or more lanes of the at least one communications channel;
increasing one or more error correction capabilities of the at least one communications channel;
triggering one or more environmental controls to change an operating state of the two or more semiconductor processing units; or
triggering retraining of at least part of the at least one communications channel.

6. The device of claim 5, wherein the one or more environmental controls include chiplet level controls corresponding to at least one of chiplet power controls, chiplet clocking controls, or chiplet workload controls.

7. The device of claim 1, wherein the one or more sensed environmental conditions include at least one of temperature, power consumption, or package stress of at least one semiconductor device package including at least one of the two or more semiconductor processing units.

8. The device of claim 1, wherein the bit error rate measurement circuitry is further configured to record the measured bit error rate in a memory in which measured bit error rates are sorted by the one or more sensed environmental conditions.

9. The device of claim 1, wherein the bit error rate measurement circuitry is further configured to measure the bit error rate using predetermined patterns that stress link characteristics of the at least one communications channel.

10. The device of claim 1, wherein the preemptive action triggering circuitry is further configured to trigger the preemptive action based on a predictive bit error rate model of bit error rates over a plurality of the one or more sensed environmental conditions.

11. The device of claim 1, wherein the preemptive action triggering circuitry is further configured to reverse the preemptive action based on at least one of the measured bit error rate or the one or more sensed environmental conditions.

12. A system comprising:
a memory recording one or more measurements of bit error rates of at least one communications channel between two or more semiconductor processing units; and
at least one processor configured to trigger, based on the one or more measurements and one or more sensed environmental conditions, a preemptive action prior to failure of the at least one communications channel.

13. The system of claim 12, wherein the one or more sensed environmental conditions relate to at least one of the two or more semiconductor processing units.

14. The system of claim 12, wherein the at least one processor is further configured to:
trigger the two or more semiconductor processing units to begin measurement of the bit error rates in response to the one or more sensed environmental conditions meeting at least one threshold condition.

15. The system of claim 12, wherein the preemptive action corresponds to at least one of:
lowering a clock rate of the two or more semiconductor processing units;
disabling one or more lanes of the at least one communications channel;
increasing one or more error correction capabilities of the at least one communications channel;
triggering one or more environmental controls to change an operating state of the two or more semiconductor processing units; or
triggering retraining of at least part of the at least one communications channel.

16. The system of claim 12, wherein the one or more sensed environmental conditions include at least one of temperature, power consumption, or package stress of at least one semiconductor device package including at least one of the two or more semiconductor processing units.

17. The system of claim 12, wherein the at least one processor is further configured to:
record the one or more measurements in a memory in which measured bit error rates are sorted by the one or more sensed environmental conditions.

18. The system of claim 12, wherein the at least one processor is further configured to:
measure the bit error rates using predetermined patterns that stress link characteristics of the at least one communications channel.

19. The system of claim 12, wherein the at least one processor is further configured to:
trigger the preemptive action based on a predictive bit error rate model of the bit error rates over a plurality of the one or more sensed environmental conditions.

20. A method comprising:
measuring, by at least one processor, a bit error rate of at least one communications channel between two or more semiconductor processing units; and
triggering, by the at least one processor and based on the measured bit error rate and one or more sensed environmental conditions, a preemptive action prior to failure of the at least one communications channel.
